(19) United States
(12) Patent Application Publication
(10) Pub. No.: US 2022/0171588 A1
(43) Pub. Date: Jun. 2, 2022

(54) IMAGE FORMING APPARATUS AND CONTROL METHOD

(71) Applicant: SHARP KABUSHIKI KAISHA, Sakai City (JP)

(72) Inventors: MIKIYA OKADA, Sakai City (JP); KUMIKO OGINO, Sakai City (JP)

(21) Appl. No.: 17/536,634

(22) Filed: Nov. 29, 2021

(30) Foreign Application Priority Data
Dec. 2, 2020 (JP) 2020-200577

(51) Int. Cl. G06F 3/12

(52) U.S. Cl. CPC G06F 3/1273; G06F 3/1253; G06F 3/1204

(57) ABSTRACT

Included are a controller that executes a job based on a setting value; a storage that stores the setting value of the executed job as setting history information; and a display unit that displays a selection screen for selecting the setting history information stored in the storage, wherein the controller accepts a sharing setting for sharing the selected setting history information with users other than the user executing the job.

### BACKGROUND OF THE INVENTION

### Field of the Invention

The present invention relates to an image forming apparatus, etc.

### Description of the Background Art

Image forming apparatuses are known that store setting values pertaining to execution of jobs, such as printing, faxing, and scanning, as setting history information.

Recently, an attempt has been made to reuse the setting history information. The setting history information includes the setting value pertaining to execution of a job. Accordingly, a user who wishes to re-execute a job that is the same as or similar to the job pertaining to such setting history information can imitatively use the setting value included in the setting history information, thereby saving time and effort of entering the setting values pertaining to execution of the job.

The setting history information is presented to a user via a display device or the like provided in the image forming apparatus. For example, Japanese Unexamined Patent Publication No. 2013-062871 describes that, if personal authentication has already been performed at the time of displaying an operation history setting screen, a personal history is set for the operation history, and if personal authentication has not yet been performed, a general history is set for the operation history.

As described in Japanese Unexamined Patent Publication No. 2013-062871, a technique has been known for changing the display mode of setting history information in accordance with whether user authentication of a device has been performed. However, as part of effective utilization of the setting history information, a technique is not known for “sharing” of the setting history information to enable users other than the user executing the job to use the setting history information pertaining to the job.

An object of the disclosure is to provide an image forming apparatus and a control method that enable sharing of setting history information among users who use the apparatus, and facilitate the execution of a job on the basis of the shared setting history information, thereby increasing work efficiency among users who share the setting history information.

### SUMMARY OF THE INVENTION

An image forming apparatus according to the disclosure includes is a controller that executes a job based on a setting value; a storage that stores the setting value of the executed job as setting history information; and a display unit that displays a selection screen for selecting the setting history information stored in the storage, wherein the controller accepts a sharing setting for sharing the selected setting history information with users other than a user executing the job.

A method of controlling an image forming apparatus that executes a job based on a setting value according to the disclosure includes storing the setting value of the executed job as setting history information; displaying a selection screen for selecting the setting history information stored in the storing; and controlling, the controlling including accepting a sharing setting for sharing the selected setting history information with users other than a user executing the job.

According to the disclosure, it is possible to provide an image forming apparatus and a control method that enable sharing of setting history information among users who use the apparatus, and facilitate the execution of a job on the basis of the shared setting history information, thereby increasing work efficiency among users who share the setting history information.

### BRIEF DESCRIPTION OF THE DRAWINGS

FIG. 1 is an external view of a multifunction peripheral according to a first embodiment.

FIG. 2 is a functional configuration diagram of the multifunction peripheral according to the first embodiment.

FIG. 3 is a table illustrating setting history information.

FIG. 4 is a flowchart illustrating the processing flow according to the first embodiment.

FIG. 5 is a table illustrating setting history information.

FIG. 6 is a flowchart illustrating the processing flow according to the first embodiment.

FIG. 7 is a diagram illustrating an operation example according to the first embodiment.

FIG. 8 is a diagram illustrating an operation example according to the first embodiment.

FIG. 9 is a diagram illustrating an operation example according to the first embodiment.

FIG. 10 is a diagram illustrating an operation example according to the first embodiment.

FIG. 11 is a diagram illustrating an operation example according to the first embodiment.

FIGS. 12A-12B are diagrams illustrating an operation example according to the first embodiment.

FIG. 13 is a diagram illustrating an operation example according to the first embodiment.

FIG. 14 is a diagram illustrating an operation example according to the first embodiment.

FIG. 15 is a functional configuration diagram of a multifunction peripheral according to a second embodiment.

FIG. 16 is a flowchart illustrating the processing flow according to the second embodiment.

FIGS. 17A-17B are diagrams illustrating an operation example according to the second embodiment.

FIG. 18 is a functional configuration diagram of a multifunction peripheral according to a third embodiment.

FIG. 19 is a flowchart illustrating the processing flow according to the third embodiment.

FIGS. 20A-20B are diagrams illustrating an operation example according to the third embodiment.

FIGS. 21A-21B are diagrams illustrating an operation example according to the third embodiment.

FIG. 22 is a functional configuration diagram of a multifunction peripheral according to a fourth embodiment.

FIG. 23 is a flowchart illustrating the processing flow according to the fourth embodiment.

FIGS. 24A-24B are diagrams illustrating an operation example according to the fourth embodiment.

FIG. 25 is a functional configuration diagram of a multifunction peripheral according to a fifth embodiment.

FIG. 26 is a flowchart illustrating the processing flow according to the fifth embodiment.

FIGS. 27A-27B are diagrams illustrating an operation example according to the fifth embodiment.

### DESCRIPTION OF THE PREFERRED EMBODIMENTS

Embodiments of the present disclosure will be described below with reference to the accompanying drawings. Note that in describing the embodiments, as an image forming apparatus, a multifunction peripheral which has a print function including copying, a facsimile function, a scanning function, a network communication function, and the like, and executes a job based on each of those functions will be described as an example. The following embodiments have been presented by way of example only for describing the present disclosure, and the technical scope of the invention as recited in the appended claims is in no way limited by the description given below.

Note that in the disclosure, a user who logs into the multifunction peripheral serving as the apparatus and executes a job (an executing user) is referred to as a “logged-in user” and is distinguished from an “other user.” Note that when there is no need to distinguish between users, they may be simply referred to as “users, etc.”

### 1. First Embodiment

A multifunction peripheral 10 according to the first embodiment is a form of a multifunction peripheral capable of sharing, with other users, setting history information based on jobs executed by a logged-in user.

1.1 Functional Configuration

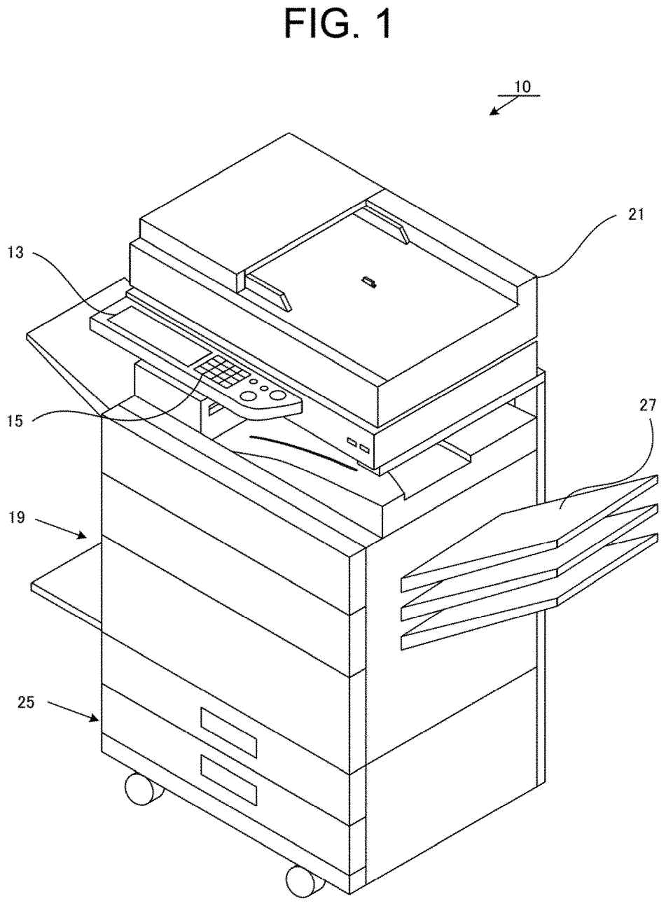

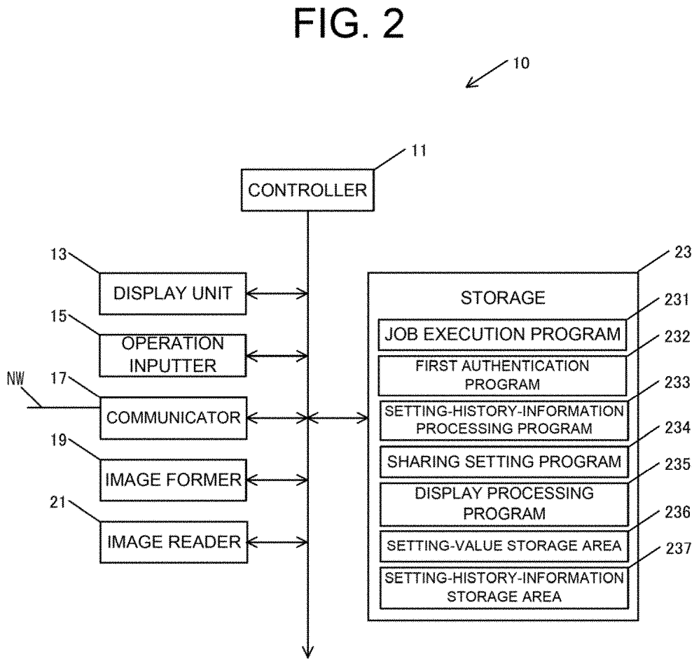

A functional configuration of the multifunction peripheral 10 according to the first embodiment will be described with reference to FIGS. 1 and 2. FIG. 1 is an external view of the overall configuration of the multifunction peripheral 10. FIG. 2 is a functional configuration diagram of the multifunction peripheral 10.

The multifunction peripheral 10 has a copy function of forming an image based on scan data generated by reading a document on a sheet of paper as a recording medium, and a print function of forming an image on a sheet of paper, on the basis of an image signal received via a network, etc., or image data stored in a portable storage medium, etc (the copy function and the print function are collectively referred to as a print function).

The multifunction peripheral 10 also has a facsimile function of performing facsimile transmission and reception via a general subscriber telephone line, a facsimile communication network, or the like. Furthermore, the multifunction peripheral 10 has a data temporary storage function of temporarily storing various types of data, such as image data and fax data, in a storage medium, and a data transmission function of transmitting the various types of data via e-mail or the like.

As illustrated in FIGS. 1 and 2, the multifunction peripheral 10 is provided with a controller 11, a display unit 13, an operation inputter 15, a communicator 17, an image former 19, an image reader 21, a storage 23, a sheet feeder 25, and a sheet discharge portion 27.

The controller 11 comprehensively controls the multifunction peripheral 10. The controller 11 includes, for example, one or more arithmetic devices, such as central processing unit (CPUs). The controller 11 reads and executes a job execution program 231, a first authentication program 232, a setting history information processing program 233, a sharing setting program 234, a display processing program 235, and the like, that are stored in the storage 23, thereby implementing the functions.

The display unit 13 displays various types of information to a user or the like. The display unit 13 may include, for example, a liquid crystal display (LCD) or an organic electro-luminescence (EL) display.

The operation inputter 15 accepts an input of information such as a setting value set by the user or the like. The operation inputter 15 can be composed of a hardware key (e.g., a numeric keypad), buttons, and the like. Note that the operation inputter 15 can be composed of a touch screen allowing input via the display unit 13. In such a case, the method of detecting an input on the touch screen can be, for example, a resistive film method, an infrared method, an electromagnetic induction method, or a capacitive sensing method.

The communicator 17 is connected to other devices via a network (NW), such as a local area network (LAN), a wide area network (WAN), the Internet, a general subscriber telephone line, or a facsimile communication network, and transmits and receives various types of information including image data and fax data, an e-mail, and the like. The communicator 17 is configured as, for example, a communicable interface, and may employ either wired or wireless connection, or both of the wired and wireless connections as the connection method.

The image former 19 forms an image based on image data on a sheet. The image former 19 feeds a sheet from the sheet feeder 25, forms an image based on the image data on the sheet, and thereafter discharges the sheet to the sheet discharge portion 27. The image former 19 can be composed of, for example, a laser printer using an electrophotographic method. The image former 19 performs image formation by using toner supplied from toner cartridges (not illustrated) corresponding to the toner colors, such as yellow (Y), magenta (M), cyan (C), and black (K).

The image reader 21 generates scan data by reading an image to be read. The image reader 21 can be composed of a scanner device or the like that converts, by an image sensor, such as a charge-coupled device (CCD) or a contact image sensor (CIS), an image into an electric signal, and generates digital data by quantizing and encoding the image signal.

The sheet feeder 25 includes a tray for storing sheets in such a state that multiple sheets are stacked. The tray can store sheets of various sizes and thicknesses according to the use. The sheet feeder 25 can be configured from a plurality of trays that individually store sheets of different sizes, such as A4 size, B5 size, or A3 size.

The sheet discharge portion 27 is provided with a plate-like stacker on which sheets discharged outside the apparatus after an image has been formed are stacked. As illustrated in FIG. 1, multiple stackers may be provided at respective sites so that sheets of different sizes can be discharged.

The storage 23 stores various programs necessary for the operation of the multifunction peripheral 10, and various types of data. The storage 23 can be composed of, for example, a volatile memory, such as a random-access memory (RAM), and a non-volatile memory, such as a solid state drive (SSD), a hard disk drive (HDD), and a read-only memory (ROM) that are semiconductor memories.

In the first embodiment, the storage 23 stores a job execution program 231, a first authentication program 232, a setting history information processing program 233, a sharing setting program 234, and a display processing program 235, and secures a setting value storage area 236 and a setting history information storage area 237.

The job execution program 231 is a program that the controller 11 reads in order to perform processing associated with the execution of the print function, the facsimile function, the scanning function, the network communication function, and the like, per job. The controller 11 controls each component involved with the execution of the job by reading the job execution program 231.

The first authentication program 232 is a program that the controller 11 reads when the logged-in user logs into the multifunction peripheral 10. The controller 11 that has read the first authentication program 232 performs authentication on the basis of, for example, a logged-in user name and a login password input via a login screen.

The setting history information processing program 233 is a program that the controller 11 reads when, for example, acquisition of a setting value or the like pertaining to the execution of a job, generation of setting history information, and various kinds of processing with respect to the setting history information are to be performed. The controller 11 acquires the setting value pertaining to the execution of the job by reading the setting history information processing program 233, and stores the acquired setting value in the setting value storage area 236. The controller 11 generates the setting history information by using the acquired setting value, and stores the generated setting history information in the setting history information storage area 237.

The sharing setting program 234 is the program read by the controller 11 when a logged-in user who is the executing user of a job performs an operation or the like to permit other users to use the setting history information pertaining to the job executed by the logged-in user (this act is referred to as “sharing” in the disclosure). The controller 11 reads the sharing setting program 234, for example, when the identifier that permits sharing displayed on the display unit 13 is selected by the logged-in user.

The display processing program 235 is a program that the controller 11 reads in display processing of the setting history information and display processing of the common screen that will be described below. The controller 11 can read the display processing program 235 and control the display unit 13 to perform the display processing for the setting history information and common screen.

The setting value storage area 236 is a storage area for storing various setting values pertaining to the execution of a job. The setting values include a setting value set by the logged-in user in executing each job, an apparatus default value held by the apparatus itself, and the like.

Note that the setting value may be a value directly input by the logged-in user via the operation inputter 15 or a touch screen or the like displayed on the display unit 13. When the multifunction peripheral 10 is connected to an external terminal device or the like (not illustrated) via the communicator 17, the controller 11 can also acquire the setting value input via a control program, such as a printer driver introduced in the external terminal device. The controller 11 stores the acquired setting value in the setting value storage area 236.

The setting history information storage area 237 is a storage area for storing the setting history information in the form of a data table. The setting history information according to the first embodiment can be constituted as history information that includes information formed of a combination of some of or all of the setting values that are stored in the setting value storage area 236 and history information related to the execution of a job, such as a job function, an executing user name, and start date and time/end date and time, and to which a job ID for uniquely identifying the above information is added.

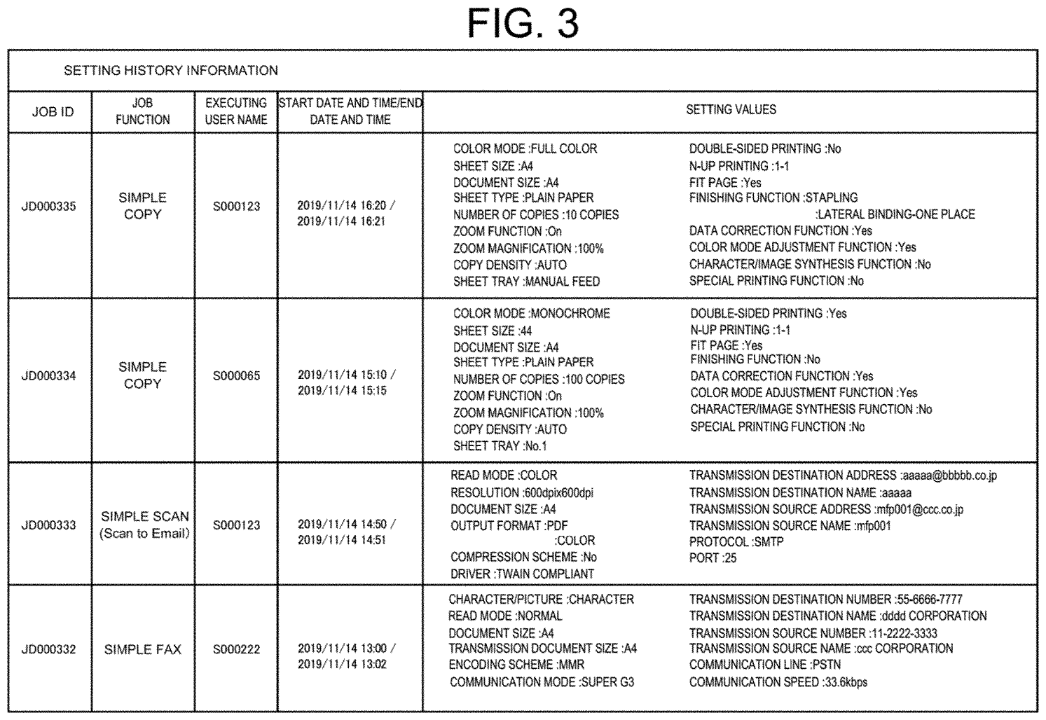

FIG. 3 is a diagram illustrating a configuration example of the setting history information. Here, for example, job ID: JD000335 indicates that it corresponds to the setting history information pertaining to a simple copy in which a user with the user name: S000123 is the executing user. The above job is a job executed by the executing user S000123 at 16:20 on Nov. 14, 2019, and ended at 16:21 on the same date. Note that set values (items) included in the setting history information are not particularly limited as long as they are the setting values stored in the setting value storage area 236. The setting values indicated in FIG. 3 are mere examples, and the setting values of the disclosure are not limited by what has been illustrated in FIG. 3 alone.

1.2 Processing Flow

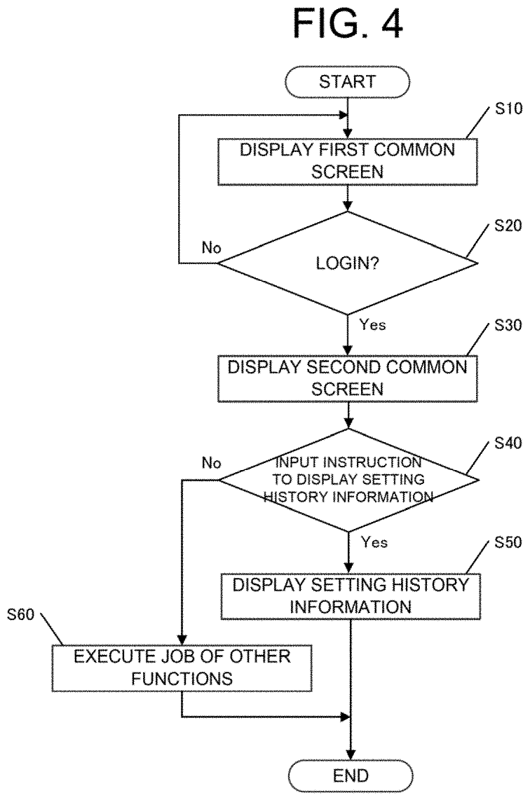

The processing flow according to the first embodiment will now be described. FIG. 4 is a flowchart illustrating the processing from the display of the common screen of the multifunction peripheral 10 to the display of the setting history information and the execution of a job of another function.

Note that the common screen is a screen on which input buttons arranged in a consolidated manner, in order to accept selection of the job function or an input of instruction to display the setting history information or the like. The input buttons have a screen configuration in which the respective functions and information are represented by illustrations with figures, characters/numbers, symbols, etc. The common screen is the so-called home screen, and functions as an interface for the user or the like.

In this specification, the common screen displayed before a logged-in user or the like logs into the apparatus or when the login authentication function is in an off state is referred to as a first common screen.

The common screen that is displayed after the logged-in user logs into the apparatus is referred to as a second common screen.

In step S10, the controller 11 reads the display processing program 235 to display the first common screen on the display unit 13.

The controller 11 displays a first common screen, for example, when the apparatus is powered on, when the apparatus is restored from a sleep mode, before a logged-in user or the like logs into the apparatus, and when the login authentication function is in an off state.

When the controller 11 accepts a login request via the first common screen, the controller 11 reads the first authentication program 232. The controller 11 then displays, on the display unit 13, a login screen for accepting an input of a logged-in user name, a login password, and the like of a logged-in user attempting to log in.

In step S20, the controller 11 accepts the input of the logged-in user name via the login screen and performs authentication. The controller 11 can, for example, store the logged-in user name and the login password in association with each other, and perform authentication by matching the logged-in user name and the login password input via the login screen.

Note that the authentication of the logged-in user can be knowledge authentication, such as logged-in user name and login password, property authentication using tokens, keys, IC cards, smart phones, etc., or biometric authentication, such as fingerprint authentication, palm print authentication, and blood vessel authentication.

When the login authentication is successful, the controller 11 displays the second common screen in step S30.

When the authentication of the logged-in user fails or the screen operation is not a login operation, the controller 11 returns the process to step S10 and leaves the display in the first common screen.

In Step S40, the controller 11 accepts the input of a display instruction of pieces of the setting history information. When there is an instruction input for displaying the setting history information, the controller 11 reads the setting history information processing program 233 and the display processing program 235.

In step S50, the controller 11, which reads the display processing program 235, displays the setting history information pertaining to the job executed by the logged-in user.

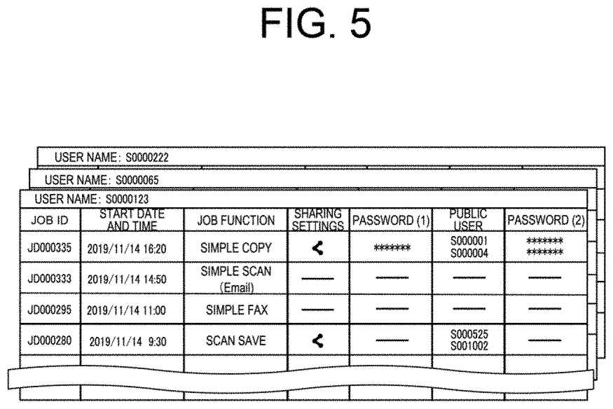

At this time, the controller 11 compiles the setting history information pertaining to the jobs executed by the logged-in user for each logged-in user, for example, in chronological order, starting with the newest one, as illustrated in FIG. 5. FIG. 5 illustrates an example in which the setting history information pertaining to the job executed by user name: S0000123, user name: S0000065, and user name: 0000222 is compiled. When the logged-in user is user name: S0000123, the controller 11 displays the result of compilation of the setting history information pertaining to the job of the user name: S0000123.

When the input in step S40 is not an instruction input for displaying the setting history information, the controller 11 executes a job of another function input by the logged-in user in step S60, and the process ends.

Note that when a job of another function is executed, the controller 11 reads the setting history information processing program 233, acquires the setting values pertaining to the execution of the job, and generates the setting history information. In such a case, the controller 11 may generate a history pertaining to the execution of the job as a job history.

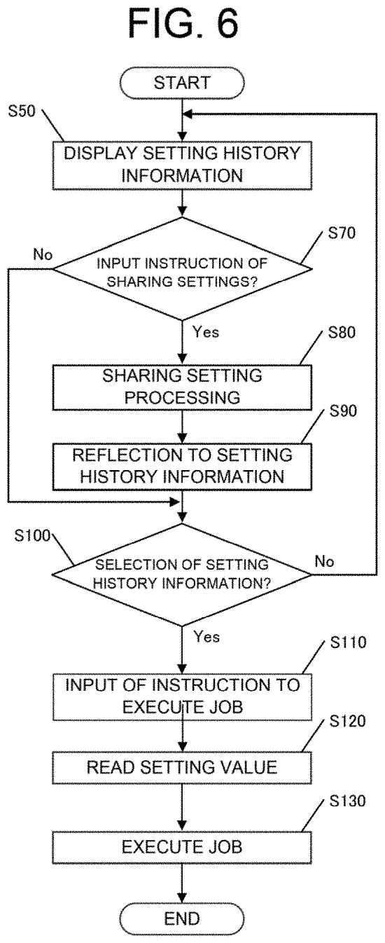

Now, a process from the display processing of the setting history information to the job execution will be described with reference to a flowchart in FIG. 6. Note that the processing in step S50 is the same as the processing in steps S50 of FIG. 4.

When the setting history information is displayed, the controller 11 determines, in step S70, whether or not an instruction to input the sharing setting has been given. The controller 11 can determine an input instruction for the sharing setting by, for example, an identifier that accepts selection of whether or not to permit sharing of the setting history information being selected by the logged-in user.

When it is determined to be an input instruction of the sharing setting, in step S80, the controller 11 performs sharing setting processing by reading the sharing setting program 234.

In step S90, the controller 11 reflects the sharing setting in the setting history information. That is, as a result of the controller 11 performing the processing, other users can use the setting history information.

After reflecting the sharing settings in the setting history information or when the input instruction for the sharing settings is not accepted in step S70, in step S100, the controller 11 determines whether the setting history information desired by the logged-in user has been selected.

When the setting history information is selected, the controller 11 accepts an input of an instruction to execute a job in step S110.

Upon accepting an input of an instruction to execute a job, in step 5120, the controller 11 reads the setting values pertaining to the setting history information.

In step S130, the controller 11 executes the job on the basis of the read setting values, and the processing ends.

Note that when the job is executed, the controller 11 reads the setting history information processing program 233, acquires the setting values pertaining to the execution of the job, and generates the setting history information. In such a case, the controller 11 may generate a history pertaining to the execution of the job as a job history.

1.3 Example of Operation

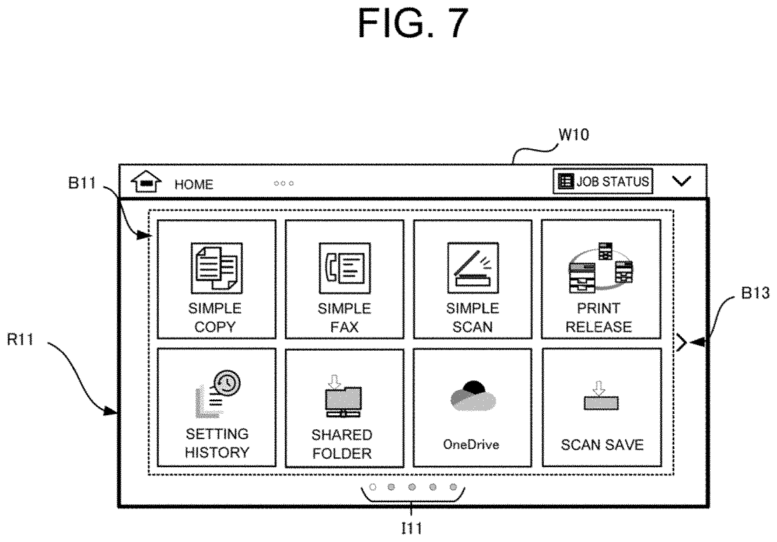

An operation example according to the first embodiment will now be described. FIG. 7 is a diagram illustrating a configuration example of the first common screen. Note that the present operation example corresponds to the operation of step S10 of FIG. 4.

A first common screen W10 is a home screen to be displayed when the apparatus is powered on, when the apparatus is restored from a sleep mode, before a logged-in user logs into the apparatus, and when the login authentication function is in an off state.

The first common screen W10 includes a job function display area R11, a job function display area switching button B13, and a job function display area indicator I11.

The job function display area R11 is an area for displaying, in a consolidated manner, job function input buttons B11 for receiving selection of each job function, and an instruction to display the setting history information, etc. The job function input buttons B11 are input buttons having a screen configuration in which the respective job functions and respective pieces of information are represented by illustrations with figures, characters/numbers, or symbols, etc.

The job function display area R11 in FIG. 7 is an example of an area composed of the job function input buttons B11, which receive selection of each job function, such as simple copy, simple fax, simple scan, print release, shared folder, OneDrive, and scan save, as the job functions, and a display instruction input for the setting history information.

The job function display area switching button B13 receives pressing by the user when the display contents of the job function display area R11 are to be switched. When the job function display area switching button B13 is pressed by the user, the display content of the job function display area R11 is switched as the job function input buttons B11 is switched.

The job function display area indicator I11 is an indicator that shows whether any job function display area is displayed. For example, when the job function display area being displayed is the content of a job function display area R11 illustrated in FIG. 7, the leftmost circle is displayed in white. For example, when the display content of the job function display area R11 is switched by pressing a job function display area switching button B13 once, the circle to the right of the leftmost circle is displayed in white.

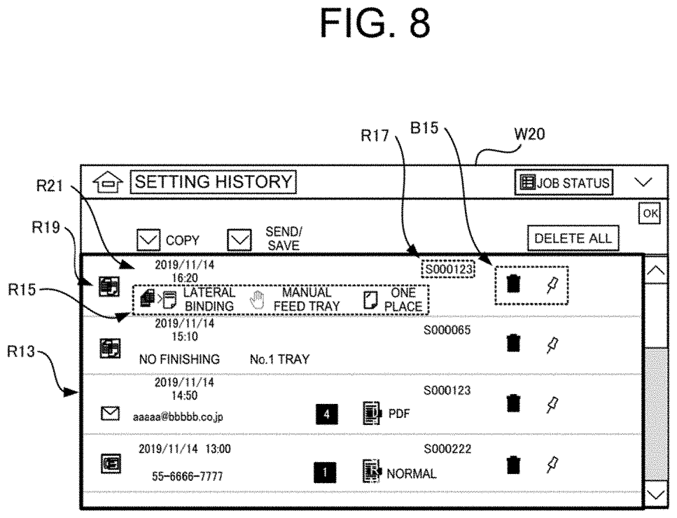

FIG. 8 illustrates a configuration example of a setting history information display screen W20 that the controller 11 displays when the job function input button B11 pertaining to an instruction to display the setting history information, as illustrated in FIG. 7, is pressed.

Since the setting history information display screen W20 displays the setting history information in a state where no logged-in user authentication is performed, the setting history information pertaining to all users can be viewed.

The setting history information display screen W20 includes a setting history information display area R13, and pieces of the setting history information pertaining to the respective jobs are displayed within the setting history information display area R13. FIG. 8 illustrates an example of displaying pieces of the setting history information pertaining to jobs executed on the basis of four types of job functions, which are simple copy by the user with the executing user name: S000123, simple copy by the user with the executing user name: S000065, simple scan (scan to email) by the user with the executing user name: S000123, and simple fax by the user with the executing user name: S000222, in chronological order from newest to oldest.

Here, each piece of the setting history information includes a setting value display area R15, a user name display area R17, a job function display area R19, a job execution date and time display area R21, and a processing selection button B15.

The setting value display area R15 is a display area for displaying the setting values included in the setting history information illustrated in FIG. 3. The setting value items to be displayed in the setting value display area R15 are not particularly limited, and an arbitrary setting value item can be selected and displayed. The figure illustrates an example in which “lateral binding” as the finishing function, “one place”, and “manual feed” as the sheet tray are displayed, as the setting value items of Simple Copy as the job function.

The user name display area R17 is a display area for displaying the name of the user who has executed the job. Here, as an example, the user with the user name: S000123 is displayed as the name of the user who has executed the job.

The job function display area R19 is an area for displaying an icon or thumbnail image of the screen configuration of the job function input button B11 so that the user can intuitively grasp whether the displayed setting history information is based on any of the job functions. As the user views the image displayed in the job function display area R19, the user can ascertain the job function pertaining to the setting history information in question.

The job execution date and time display area R21 is a display area for displaying the date and time when the job was executed.

The processing selection button B15 accepts selection of predetermined processing (for example, deletion or pinning) for the setting history information. For example, as the logged-in user selects a trash box mark displayed as the processing selection button B15, the logged-in user can delete the setting history information.

For example, the logged-in user can select a pin mark displayed as the processing selection button B15 to preferentially display the setting history information.

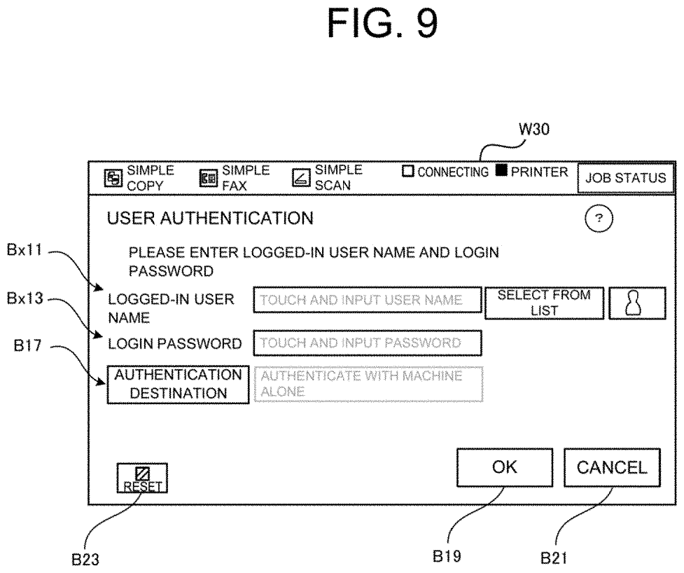

FIG. 9 is a diagram illustrating a configuration example of a login screen displayed by the controller 11. Note that the operation corresponds to step S20 of FIG. 4.

A login screen W30 includes a logged-in user name input box Bx11, a login password input box Bx13, an authentication destination selection button B17, an OK button B19, a cancel button B21, and a reset button B23.

The logged-in user name input box Bx11 is an input box that accepts an input of a logged-in user name of a logged-in user who attempts to log into the multifunction peripheral 10.

The login password input box Bx13 is an input box that accepts an input of a login password associated with the logged-in user name of the logged-in user who attempts to log into the multifunction peripheral 10.

The authentication destination selection button B17 is a button that accepts selection of a destination where the logged-in user is to be authenticated. FIG. 9 illustrates an example in which a machine (the multifunction peripheral 10) alone is selected as the authentication destination of the logged-in user. Note that when logged-in users are to be managed by another device, such as a management server, via a network (NW), it is possible to select the name of the other device, or positional information (such as an IP address) of the other device on the network.

The OK button B19 is a button that accepts a login authentication operation by the logged-in user. The cancel button B21 is a button that accepts cancellation of the login authentication operation by the logged-in user.

The reset button B23 is a button that accepts a pressing operation thereof by the logged-in user when the input and operation content is to be restored to a default value.

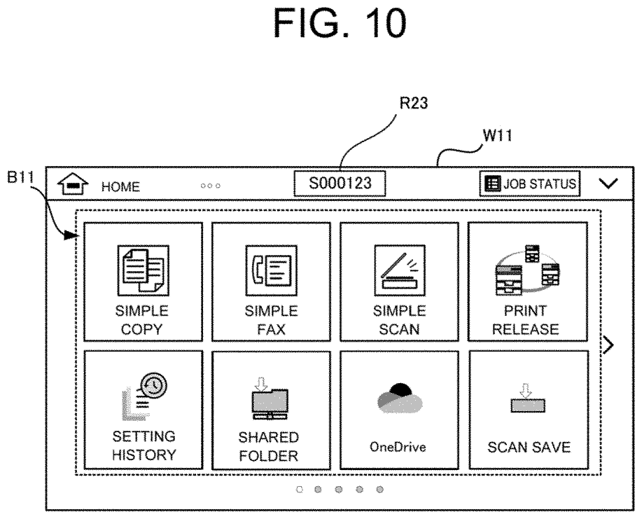

FIG. 10 is a diagram illustrating a configuration example of a second common screen W11. Note that the operation corresponds to the operation of step S30 of FIG. 4.

The second common screen W11 is a home screen to be displayed when authentication of the logged-in user is successful in step S20 of FIG. 4.

The configuration of the second common screen W11 can be made the same as that of the first common screen W10, but is different in that a logged-in user name display area R23 is included.

The logged-in user name display area R23 is a display area for displaying the name of a logged-in user who has successfully logged into the multifunction peripheral 10. FIG. 10 illustrates an example in which the user with the user name: S000123 is displayed as the logged-in user. Note that in the example illustrated in FIG. 10, a display position of the logged-in user name display area R23 is set to the upper portion of the second common screen W11. However, as long as the logged-in user name can be recognized by a viewing user, the display position is not limited to the above.

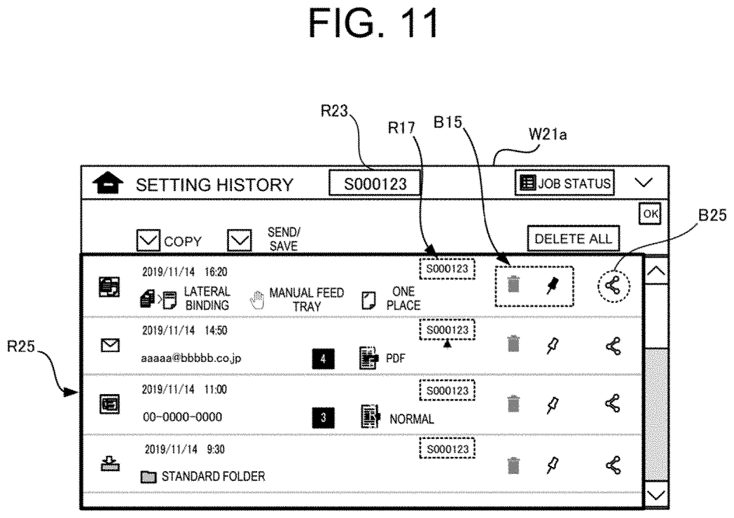

FIG. 11 illustrates a configuration example of a setting history information display screen W21a that the controller 11 displays when the job function input button B11 pertaining to an instruction to display the setting history information, as illustrated in FIG. 10, is pressed. Note that this operation corresponds to the processes of steps S40 and S50 in FIG. 4.

The configuration of the setting history information display screen W21a can be made the same as that of the setting history information display screen W20. Accordingly, the same reference characters are assigned to the same configuration.

The setting history information display screen W21a includes a setting history information display area R25 as in the setting history information display screen W20. In the setting history information display area R25, pieces of the setting history information pertaining to respective jobs are displayed. Here, as indicated by the user name display area R17, pieces of the setting history information pertaining to jobs executed by the user with the logged-in user name displayed in the logged-in user name display area R23 are displayed.

FIG. 11 illustrates an example in which pieces of the setting history information pertaining to jobs executed by the logged-in user with the user name: S000123 are compiled and displayed. When the user presses the job function input button B11 pertaining to an instruction to display the setting history information on the second common screen W11 in a state where a login to the multifunction peripheral 10 is completed, the controller 11 compiles and displays pieces of the setting history information pertaining to jobs executed by the logged-in user, as illustrated in FIG. 5.

With the configuration described above, the logged-in user can ascertain the setting history information pertaining to the jobs that user has executed. At this time, in the setting history information display area R25, a sharing setting button B25 that selects whether or not to allow other users to use the relevant setting history information is displayed in addition to the processing selection button B15.

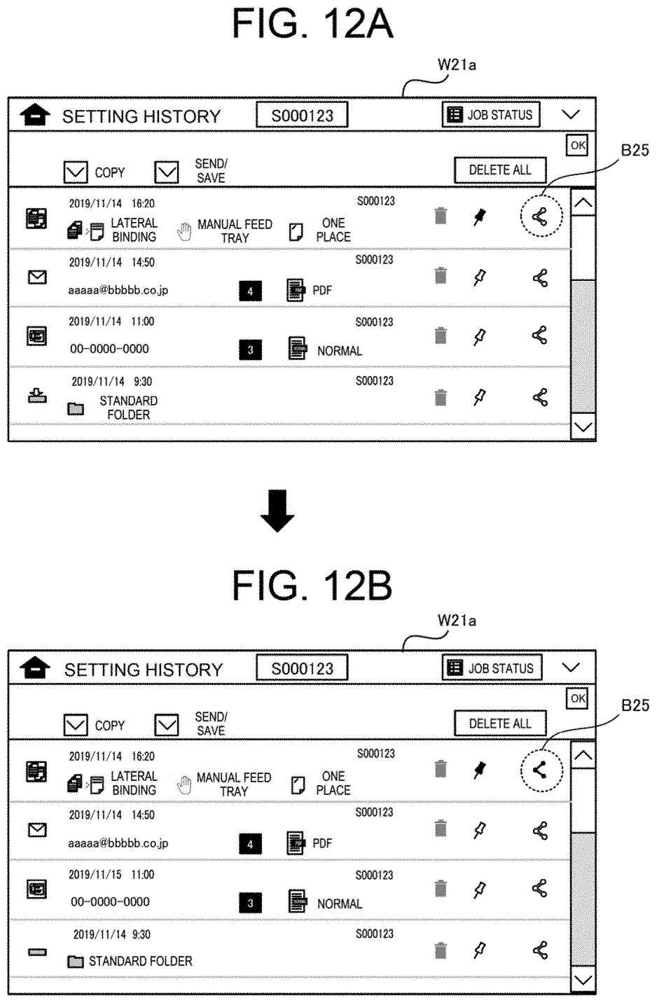

FIGS. 12A-12B illustrate the screen transition of the setting history information display screen W21a by pressing the sharing setting button B25. Note that this operation corresponds to the processes of steps S50 to S90 in FIG. 6.

When the logged-in user determines the setting history information set for sharing, the user presses the sharing setting button B25 corresponding to the setting history information (FIG. 12A).

When the sharing setting button B25 is pressed, the controller 11 selects and displays (e.g., displays in a predetermined selection color) the sharing setting button B25. The selection display of the sharing setting button B25 means that the setting history information pertaining to the job of simple copy by the executing user name: S000123 has been shared (FIG. 12B).

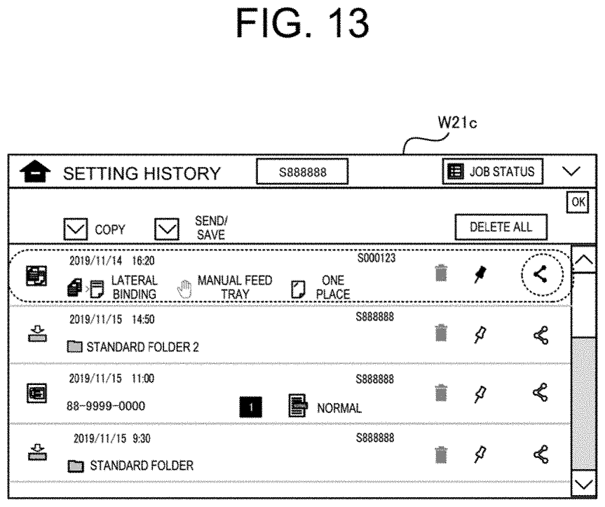

FIG. 13 illustrates sharing of the setting history information pertaining to the job of simple copy by the user with the executing user name: S000123 by the processing pertaining to steps S50 to S90 of FIG. 6 and the operation pertaining to FIGS. 12A-12B.

FIG. 13 is a configuration example of when another user with the user name: S888888 logs into the multifunction peripheral 10 and displays a setting history information display screen W21c.

The setting history information display screen W21c displays the setting history information pertaining to the job of simple copy by the user with the executing user name: S000123 in addition to the setting history information pertaining to the job executed by another user with the user name: S888888 as a logged-in user (in the dotted line frame in the drawing). This allows the other user with user name: S888888 to execute jobs using the setting history information of the user with the executing user name: S000123. The job by selecting the setting history information set for sharing can be performed by the processing based on step S100 to S130 of FIG. 6.

When a job is executed on the basis of the sharing history information set for sharing, the setting history information is normal setting history information. At this time, the setting history information set for sharing can be kept on display.

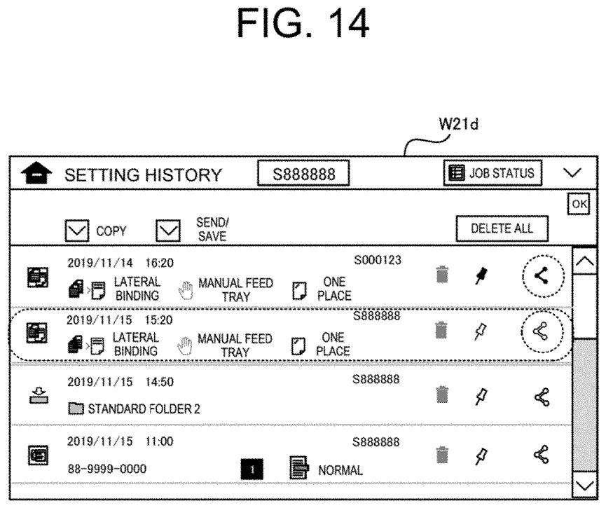

FIG. 14 is a configuration example of setting history information display screen W21d after a job is executed on the basis of the setting history information set for sharing.

When the logged-in user with the user name: S888888 executes a job using the setting history information of the user with the executing user name: S000123 in the state illustrated in FIG. 13, the setting history information used remains displayed in the top row. In contrast, the setting history information corresponding to the job executed by using the relevant setting history information is displayed as setting history information in the state in which the sharing setting has been canceled (no normal sharing setting), as illustrated in the dotted frame in the drawing.

Note that the setting history information can be protected to enable reuse by the same executing user. When the setting history information is protected and shared, the setting history information set for sharing is displayed in the top row of the setting history information display screen as in the case of normal protection. When the setting history information is to be used temporarily, it can be protected, and when it is to be saved, it can be protected and shared. In such a case, it is preferable to link the ON/OFF state of protection between users.

The shared setting history information set can be deleted after the protection is removed. When shared setting history information is deleted, it is preferable that the setting history information that was shared among users is deleted.

Furthermore, when sharing is canceled, the setting history information pertaining to sharing by users other than the user with whom the information was first shared is hidden, while the setting history information shared with the user with whom the information was first shared is returned to setting history information with no normal sharing settings. This can prevent the use of setting history information with the sharing setting canceled.

As described above, the first embodiment can provide a multifunction peripheral capable of sharing setting history information based on a job executed by a logged-in user who has logged into the apparatus with other users.

### 2. Second Embodiment

The multifunction peripheral 30 according to the second embodiment is a form of multifunction peripheral in which, when the setting history information based on a job executed by a logged-in user who has logged into the apparatus is to be shared with other users, it is possible to select other users to whom the shared setting history information is to be disclosed.

2.1 Functional Configuration

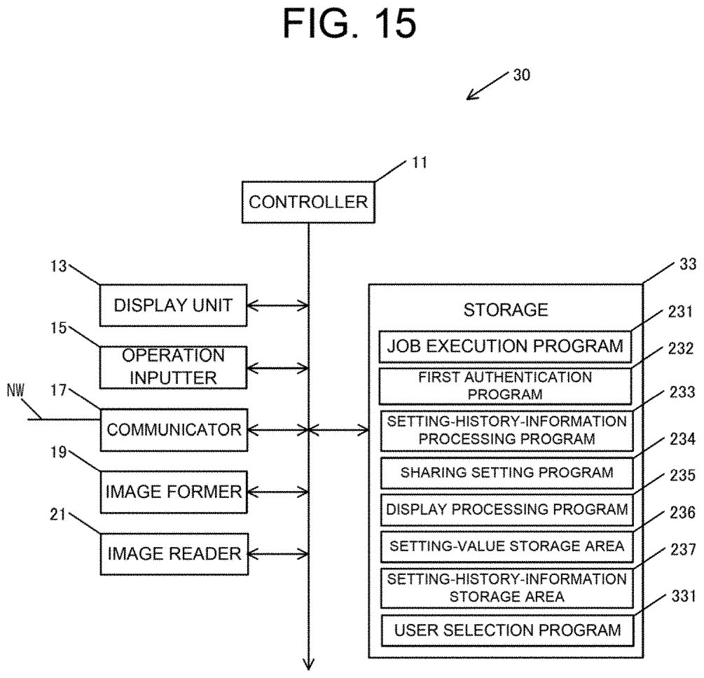

The overall configuration of a multifunction peripheral 30 according to the second embodiment can be made the same as that of the multifunction peripheral 10 according to the first embodiment. Therefore, the drawing describing the overall configuration is omitted. FIG. 15 illustrates a functional configuration of the multifunction peripheral 30. Note that the same functions as those of the multifunction peripheral 10 are denoted by the same signs and the descriptions thereof are omitted.

The multifunction peripheral 30 includes a storage 33 in place of the storage 23 of the multifunction peripheral 10. The storage 33 stores a job execution program 231, a first authentication program 232, a setting history information processing program 233, a sharing setting program 234, a display processing program 235, and a user selection program 331, and secures a setting value storage area 236 and a setting history information storage area 237.

The user selection program 331 is a program that is read by the controller 11 when another user (hereinafter referred to as a public user) publishing setting history information to be shared is selected. At this time, the controller 11 also reads the display processing program 235 to display a selection screen to accept the selection of the public user.

2.2 Processing Flow

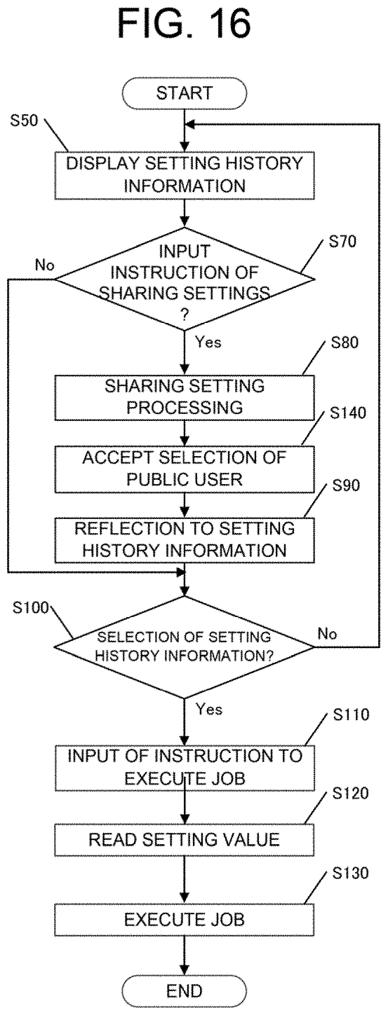

A processing flow according to the second embodiment will now be explained. FIG. 16 is a flowchart illustrating processing to be performed from display processing of the setting history information to job execution. Note that the processing flow according to the second embodiment includes public user selection acceptance processing between step S80 and S90 of FIG. 6, and other processing can be performed as the same processing. Therefore, other processing is omitted while being denoted by the same step number.

Note that whether or not to accept the selection of public users can be selected in the system settings.

After the sharing setting processing is performed in step S80, the controller 11 performs a selection acceptance of a public user in step S140. Specifically, the controller 11 reads the user selection program 331 and the display processing program 235.

When the logged-in user selects a public user via a displayed public user selection screen, the controller 11 reflects the sharing setting and the public user in the setting history information in step S90.

The processing of step S100 and the subsequent steps can be performed in the same manner as in the first embodiment.

2.3 Example of Operation

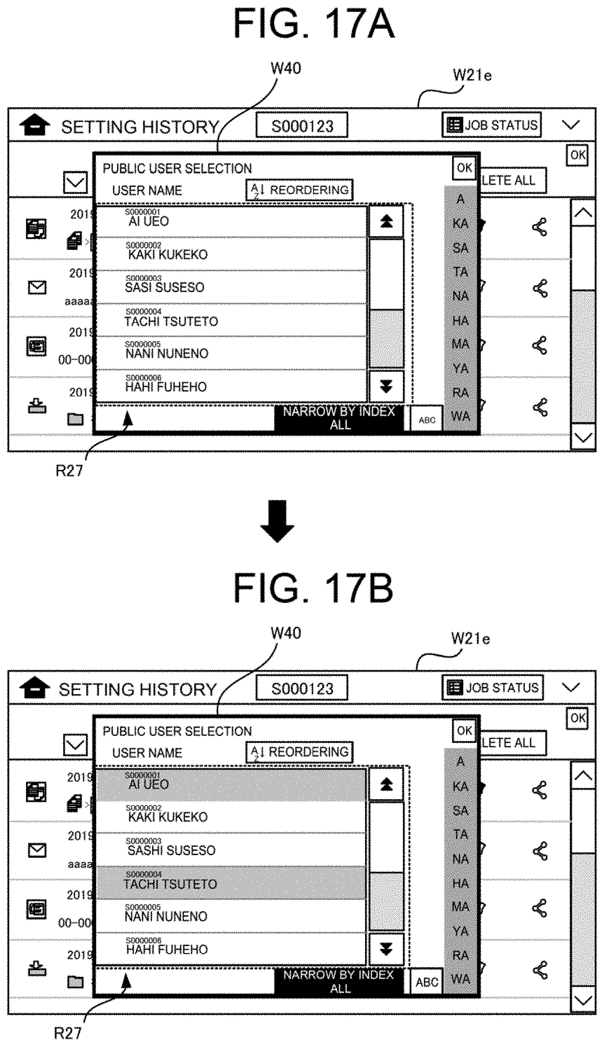

An operation example according to the second embodiment will now be described. FIGS. 17A-17B are a configuration example of a public user selection screen W40 displayed on a setting history information display screen W21e.

The public user selection screen W40 includes a user display area R27 that lists users other than the logged-in user of the multifunction peripheral 30 so that the public user can be selected. FIG. 17A is an example in which six user names from user name: S0000001 (Ai Ueo) to user name: S0000006 (Hahi Fuheho) are displayed in the user display area R27 as candidates for publication of setting history information set for sharing.

The logged-in user selects the user name of the public user of the setting history information set for sharing in the state illustrated in FIG. 17A. The selected user name (user name: S0000001 (Ai Ueo), User: S0000004 (Tachi Tsuteto)) are selected and displayed as illustrated in FIG. 17B. Note that the number of users that can be selected may be one or more. The controller 11 sets the selected users as public users and applies them to the shared setting history information.

As described above, according to the second embodiment, when the setting history information based on a job executed by a logged-in user who has logged into the apparatus is shared with other users, the public users to whom the setting history information set for sharing is disclosed can be limited. This prevents users other than the public user from viewing and using the shared setting history information, so the logged-in user can prevent unintended use of the setting history information.

### 3. Third Embodiment

The multifunction peripheral 50 according to the third embodiment is a form of a multifunction peripheral in which, when sharing setting history information based on a job executed by a logged-in user who has logged into the apparatus with other users, it is possible to set authentication information for authenticating the use of the setting history information set for sharing.

3.1 Functional Configuration

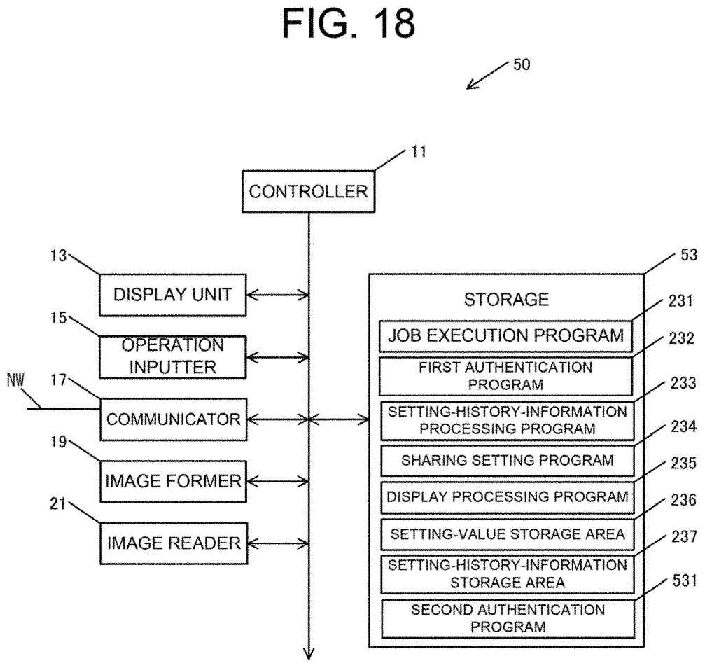

The overall configuration of a multifunction peripheral 50 according to the third embodiment can be made the same as that of the multifunction peripheral 10 according to the first embodiment. Therefore, the drawing describing the overall configuration is omitted. FIG. 18 illustrates a functional configuration of the multifunction peripheral 50. Note that the same functions as those of the multifunction peripheral 10 are denoted by the same signs and the descriptions thereof are omitted.

The multifunction peripheral 50 includes a storage 53 in place of the storage 23 of the multifunction peripheral 10. The storage 53 stores a job execution program 231, a first authentication program 232, a setting history information processing program 233, a sharing setting program 234, a display processing program 235, and a second authentication program 531, and secures a setting value storage area 236 and a setting history information storage area 237.

The second authentication program 531 is a program that is read by the controller 11 during the setting of authentication information and authentication processing of the setting history information set for sharing. At this time, the controller 11 also reads the display processing program 235 to display an authentication information acceptance screen that accepts the setting or input of authentication information.

3.2 Processing Flow

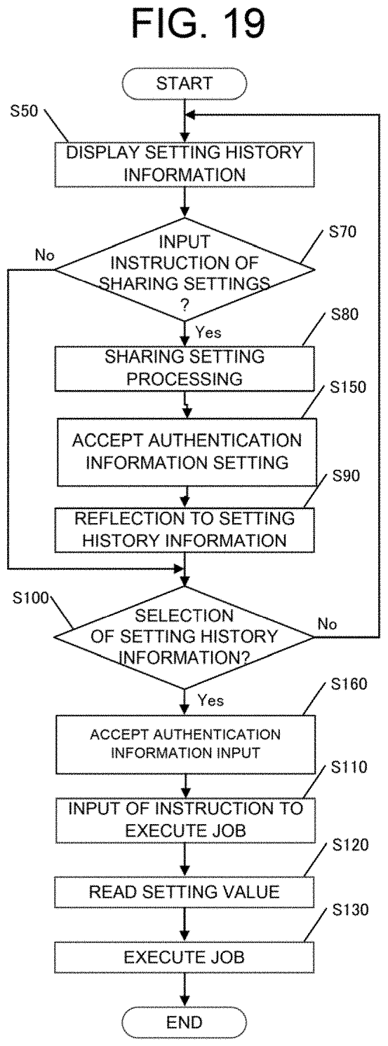

The processing flow according to the third embodiment will now be described. FIG. 19 is a flowchart illustrating processing to be performed from display processing of the setting history information to job execution. Note that the processing flow according to the third embodiment includes setting acceptance processing of authentication information between steps S80 and S90 of FIG. 6, and authentication information input acceptance processing between steps S100 and S110. Therefore, other processing is omitted while being denoted by the same step number.

Note that whether or not to attach authentication information to the shared setting history information can be selected in the system settings.

After the sharing setting processing is performed in step S80, the controller 11 performs the setting acceptance of the authentication information in step S150. Specifically, the controller 11 reads the second authentication program 531 and the display processing program 235.

When the authentication information is set by the logged-in user via a displayed authentication information setting screen, the controller 11 reflects the sharing setting and the authentication information in the setting history information in step S90.

Next, in step S100, when logged-in user (in this case, the logged-in user is different from the logged-in user set for sharing) selects the setting history information, the controller 11 displays an authentication information input screen for authenticating the use of the setting history information in step S160.

After the inputted authentication information is accepted in step S160, the controller 11 accepts an input of a job execution instruction in step S110.

The processing in step S120 and the subsequent steps can be performed in the same manner as in the first embodiment.

3.3 Example of Operation

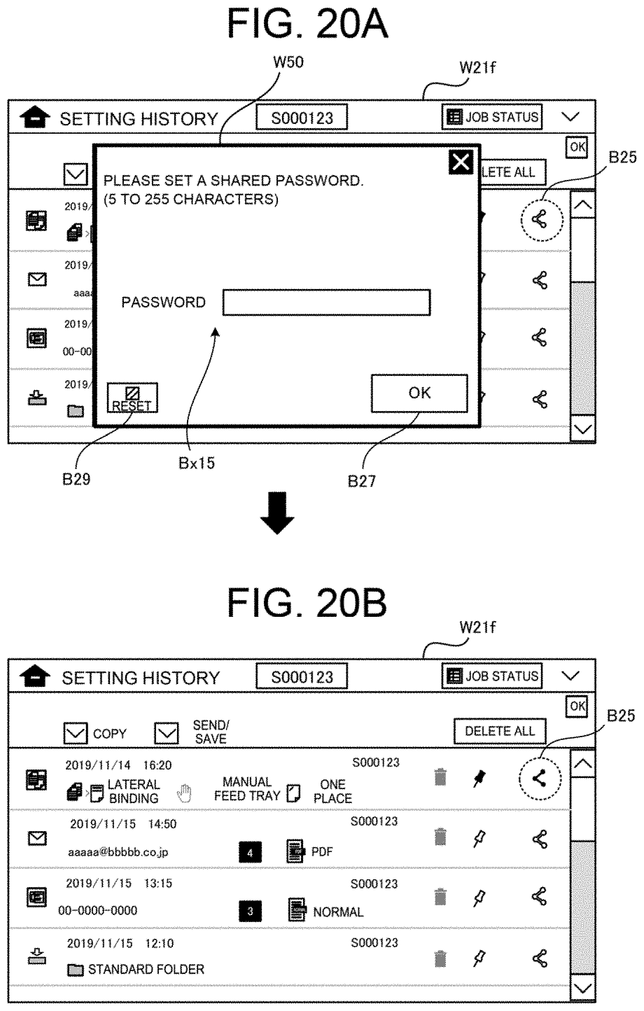

An operation example according to the third embodiment will now be described. FIGS. 20A-20B are a configuration example of an authentication information setting screen W50 displayed on a setting history information display screen W21f.

As illustrated in FIG. 20A, the authentication information setting screen W50 is a setting screen displayed by the controller 11 in response to the pressing of the sharing setting button B25. The authentication information setting screen W50 includes a password setting box Bx15 that accepts the setting of a password as authentication information, an OK button B27, and a reset button B29.

The password setting box Bx15 is an input box that accepts a setting input of a password as authentication information by the logged-in user.

The OK button B27 is a button that accepts a password setting operation by the logged-in user. The reset button B29 is a button that accepts a pressing operation by the user when the input and operation content is to be restored to a default value.

When a password is set in the password setting box Bx15 by the user and the OK button B27 is pressed, the controller 11 selects and displays the sharing setting button B25 pertaining to the setting history information for which the password was set, as illustrated in FIG. 20B.

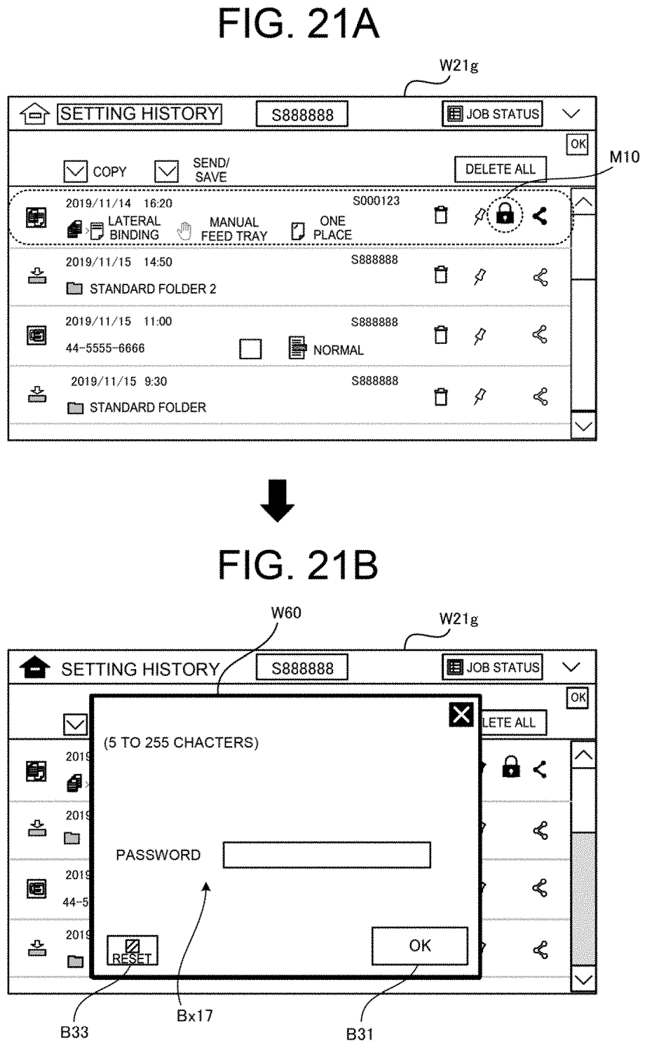

FIGS. 21A-21B are a configuration example of a setting history information display screen W21g displayed when another user of user name: S888888 logs into the multifunction peripheral 50.

The setting history information display screen W21g illustrated in FIG. 21A displays setting history information pertaining to the job of simple copy by the user of executing user name: S000123 in addition to setting history information pertaining to the job executed by the user of user name: S888888, as in the example in FIG. 13 (within the dotted line frame in the drawing).

At this time, for setting history information for which a password is set as authentication information, a key mark M10 is attached to indicate that authentication by inputting the password is required to use the setting history information.

When the setting history information with the key mark M10 is selected by another user, the controller 11 displays an authentication information input screen W60 illustrated in FIG. 21B.

The authentication information input screen W60 includes a password input box Bx17 that accepts an input of a password as authentication information, an OK button B31, and a reset button B33.

The password input box Bx17 is an input box that accepts the input of a password as the set authentication information.

The OK button B31 is a button that accepts a password input operation by another user. The reset button B33 is a button that accepts pressing thereof by another user when the input and operation contents are to be restored to a default.

When a password is entered in the password input box Bx17 by another user and the OK button B31 is pressed, the controller 11 checks the entered password against the password set in the relevant setting history information. If both passwords match, the controller 11 authenticates the sharing of the relevant setting history information.

As described above, according to the third embodiment, when setting history information based on a job executed by a logged-in user who has logged into the apparatus is shared with other users, authentication information can be set for the setting history information set for sharing. This can enhance security because the setting history information cannot be used unless the authentication information set for the setting history information set for sharing is correctly input.

### 4. Fourth Embodiment

A multifunction peripheral 70 according to the fourth embodiment is a form of a multifunction peripheral capable of inquiring whether or not to set the setting history information for sharing when the setting history information based on a job executed by a logged-in user who has logged into the apparatus has been used a predetermined number of times or more.

4.1 Functional Configuration

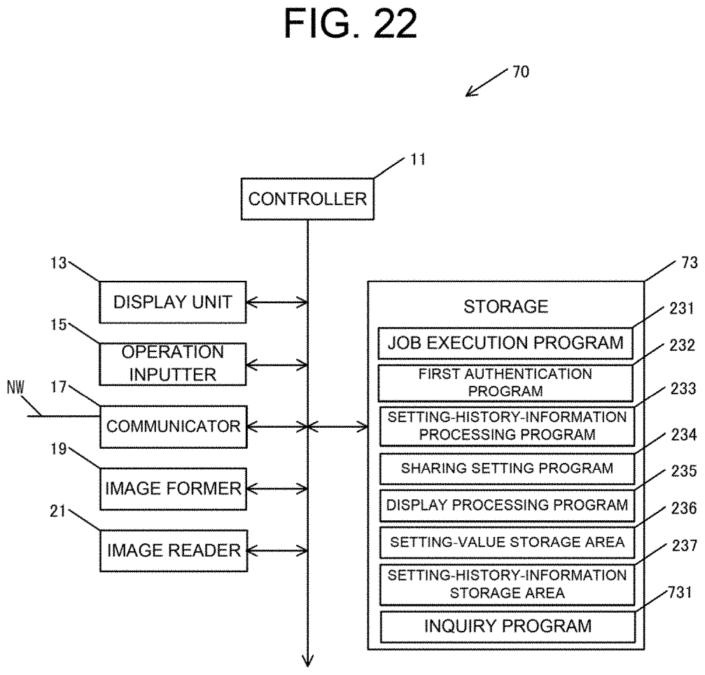

The overall configuration of a multifunction peripheral 70 according to the fourth embodiment can be made the same as that of the multifunction peripheral 10 according to the first embodiment. Therefore, the drawing describing the overall configuration is omitted. FIG. 22 illustrates a functional configuration of the multifunction peripheral 70. Note that the same functions as those of the multifunction peripheral 10 are denoted by the same signs and the descriptions thereof are omitted.

The multifunction peripheral 70 includes a storage 73 in place of the storage 23 of the multifunction peripheral 10. In the first embodiment, the storage 73 stores a job execution program 231, a first authentication program 232, a setting history information processing program 233, a sharing setting program 234, a display processing program 235, and an inquiry program 731, and secures a setting value storage area 236 and a setting history information storage area 237.

The inquiry program 731 is a program that is read by the controller 11 when determining whether or not the same setting history information has been used a predetermined number of times or more (when determining whether or not a job based on the same setting history information has been executed multiple times). The controller 11 inquires whether or not to set the setting history information for sharing. At this time, the controller 11 displays an inquiry screen by also reading the display processing program 235.

4.2 Processing Flow

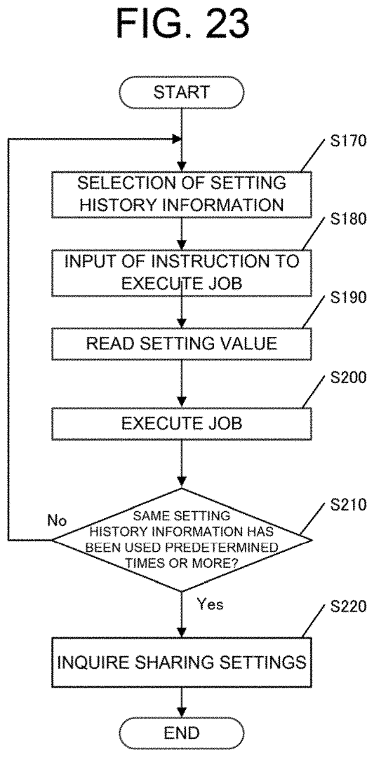

Next, a processing flow according to the fourth embodiment will be described. FIG. 23 is a flowchart illustrating processing to be performed from selection of the setting history information to shared setting inquiry.

When the setting history information pertaining to the execution of a job is selected by the user in step S170, the controller 11 accepts an input of an instruction for the execution of the job in step S180.

In step S190, the controller 11 reads the setting values pertaining to the setting history information.

In step S200, the controller 11 executes the job on the basis of the read setting values.

In step S210, the controller 11 reads the inquiry program 731 to determine whether or not the same setting history information has been used for a predetermined number of times or more.

If the same setting history information has been used for a predetermined number of times or more, in step S220, the controller 11 inquires whether or not to set the setting history information for sharing, and ends the process. Note that although the predetermined number of times is not particularly limited. For example, if the predetermined number of times is set to three times, the controller 11 displays an inquiry screen to inquire whether or not to set the setting history information for sharing when the same setting history information is used three times.

4.3 Example of Operation

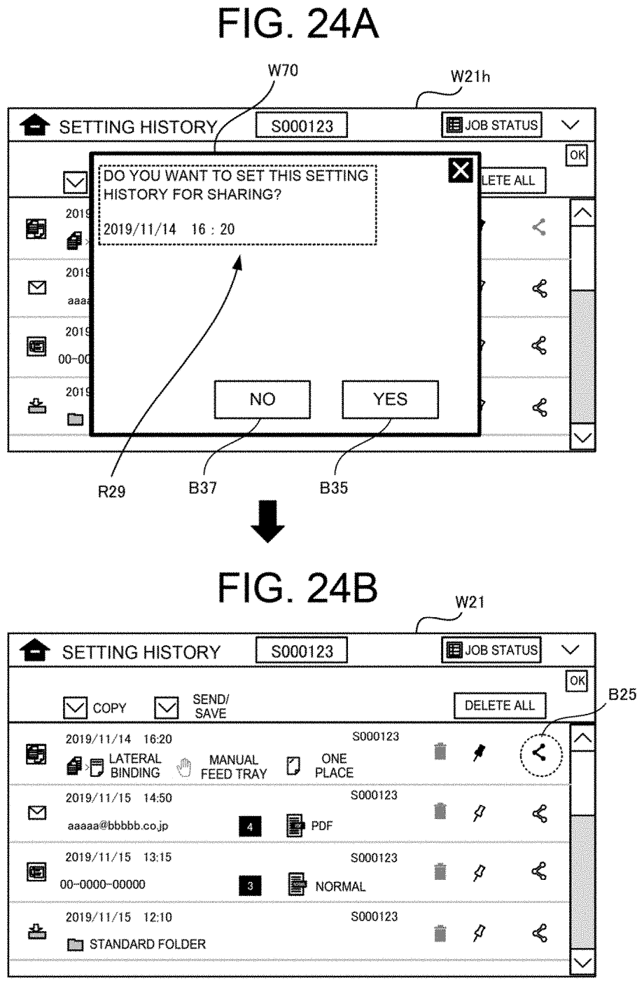

An operation example according to the fourth embodiment will now be described. FIGS. 24A-24B are a configuration example of an inquiry screen W70 displayed on a setting history information display screen W21h.

As illustrated in FIG. 24A, the inquiry screen W70 is an inquiry screen displayed by the controller 11 when the same setting history information has been used a predetermined number of times or more. The inquiry screen W70 includes an inquiry content display area R29, a “YES” button B35, and a “NO” button B37.

The inquiry content display area R29 is a display area that displays the inquiry content (the content that prompts the setting of setting history information for sharing). FIG. 24A is an example in which “Do you want to set this setting history for sharing? and “inquiry time (2019 Nov. 14 16:20)” as the inquiry content, but the inquiry content is not limited to the content illustrated in FIG. 24A. Any display format is acceptable as long as the content prompts the setting of setting history information for sharing.

The “YES” button B35 is a button that the logged-in user presses when accepting the inquiry content. The “NO” button B37 is a button that the logged-in user presses when not accepting the inquiry content.

When the inquiry content is accepted by the logged-in user and the “YES” button B35 is pressed, the controller 11 selects and displays the sharing setting button B25 as illustrated in FIG. 24B, and notifies the user that the relevant setting history information has been set for sharing.

As described above, according to the fourth embodiment, when setting history information based on a job executed by a logged-in user who has logged into the apparatus has been used a predetermined number of times or more, it is possible to inquire whether or not the setting history information should be set for sharing. This allows the user to ascertain the frequency of use of the setting history information and to be aware that it is possible to improve convenience among users by setting the setting history information for sharing.

### 5. Fifth Embodiment

A multifunction peripheral 90 according to the fifth embodiment is a form of a multifunction peripheral capable of retrieving shared setting history information.

5.1 Functional Configuration

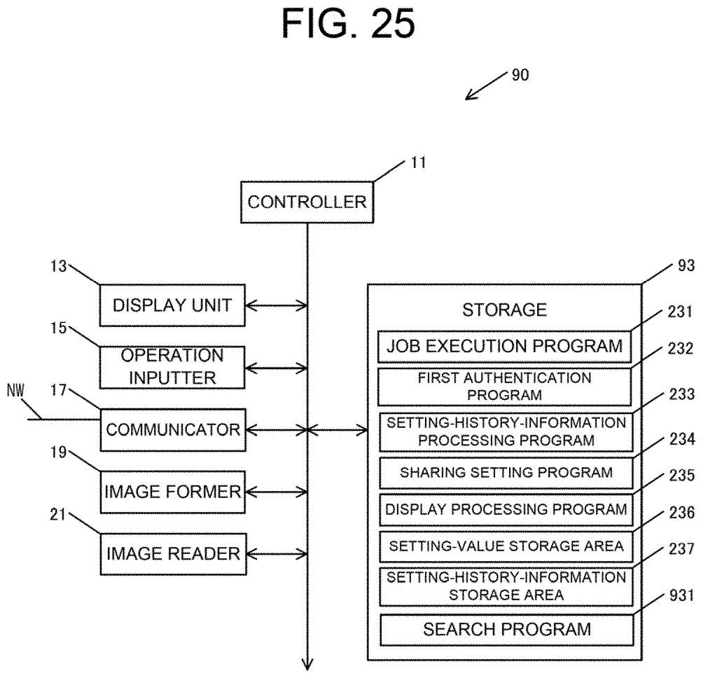

The overall configuration of a multifunction peripheral 90 according to the fifth embodiment can be made the same as that of the multifunction peripheral 10 according to the first embodiment. Therefore, the drawing describing the overall configuration is omitted. FIG. 25 illustrates a functional configuration of the multifunction peripheral 90. Note that the same functions as those of the multifunction peripheral 10 are denoted by the same signs and the descriptions thereof are omitted.

The multifunction peripheral 90 includes a storage 93 in place of the storage 23 of the multifunction peripheral 10. In the first embodiment, the storage 93 stores a job execution program 231, a first authentication program 232, a setting history information processing program 233, a sharing setting program 234, a display processing program 235, and a search program 931, and secures a setting value storage area 236 and a setting history information storage area 237.

The search program 931 is a program that the controller 11 reads when searching the setting history information set for sharing. At this time, the controller 11 displays a search screen by also reading the display processing program 235.

5.2 Processing Flow

Next, a processing flow according to the fifth embodiment will be described. Note that the search processing of the setting history information according to the fifth embodiment can be performed at any timing without requiring any special processing, provided that the display processing of the setting history information by the logged-in user is performed in steps S40 and S50 of FIG. 4.

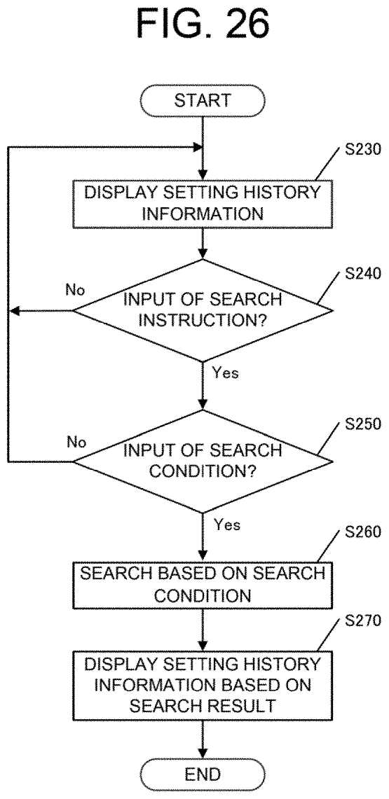

FIG. 26 is a flowchart illustrating processing to be performed from display processing of the setting history information to display processing of setting history information based on the search result.

First, in accordance with the processing pertaining to steps S40 and S50 of FIG. 4, in step S230, the controller 11 displays the setting history information.

In step S240, the controller 11 determines whether or not an input of a search instruction has been accepted. Note that the controller 11 can determine that an input of a search instruction has been accepted by, for example, receiving the pressing of a specific button for accepting the input of the search instruction.

Upon accepting the input of the search instruction, the controller 11 determines, in step S250, whether or not the search condition has been input.

When the search condition is input, the controller 11 searches the setting history information set for sharing on the basis of the input search conditions (search values) in step S260.

Then, in step S270, the controller 11 displays the setting history information set for sharing on the basis of the search result and ends the processing.

5.3 Example of Operation

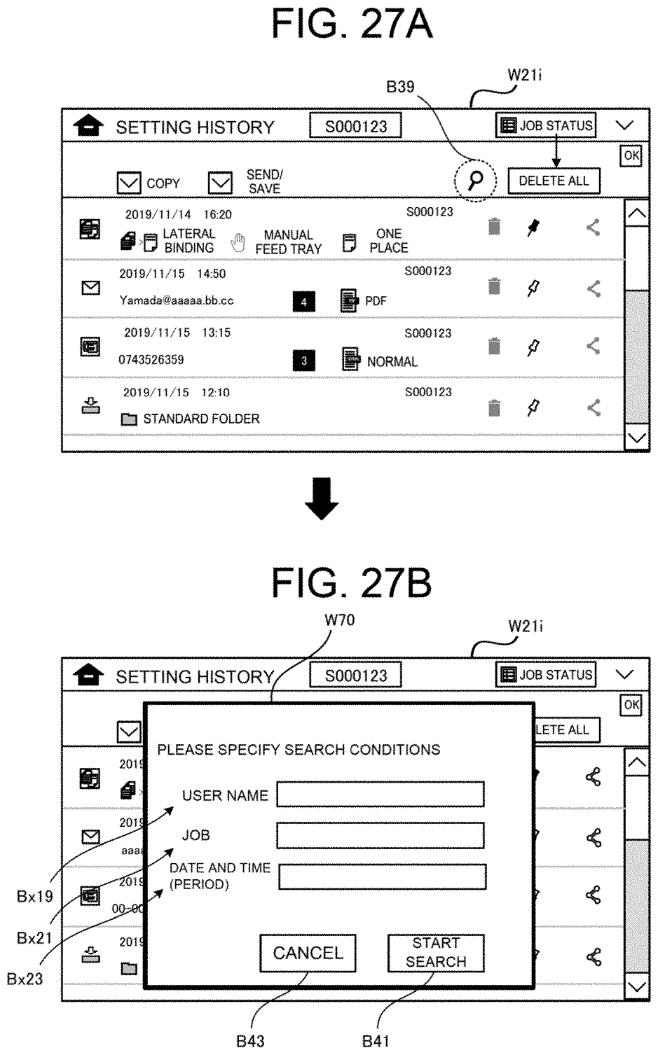

An operation example according to the fifth embodiment will now be described. FIG. 27A is a configuration example of a setting history information display screen W21i including a search instruction input button B39 for accepting an input of a search instruction.

In the state illustrated in FIG. 27A, when the search instruction input button B39 is pressed by the user, the controller 11 displays a search screen W70 illustrated in FIG. 27B.

The search screen W70 includes a user name input box Bx19, a job input box Bx21, a date/time (period) input box Bx23, a search start button B41, and a cancel button B43 for accepting input of search conditions.

The user name input box Bx19 is an input box that accepts the input of a user name as a search value when searching for setting history information set for sharing.

The job input box Bx21 is an input box that accepts the input of a job function as a search value when searching for setting history information set for sharing.

The date/time (period) input box Bx23 is an input box that accepts the date and time of job execution or execution period as a search value when searching for setting history information set for sharing.

The search start button B41 is a button that is pressed by the user or the like when the input of the search value to each input box is completed and the search is started. When the search start button B41 is pressed, the controller 11 searches the setting history information set for sharing on the basis of the search values entered in the respective input boxes. Note that each search value is not limited to the user name, job function, or job execution date and time (period) described above. It is also possible to use specific setting values included in the setting history information as search values.

The cancel button B43 is a button that a user or the like presses when canceling the search processing.

The controller 11 makes a list of the setting history information that matches the search conditions and displays it on the setting history information display screen (not illustrated).

As described above, according to the fifth embodiment, even when a large volume of setting history information set for sharing is accumulated, the setting history information set for sharing can be efficiently searched using a predetermined search value. This enables users or the like to acquire the desired setting history information without fail, so that the setting history information set for sharing can be used effectively.

The present invention is not limited to the embodiments described above, and various modifications can be made. That is, an embodiment obtained by combining technical means appropriately modified without departing from the scope of the present invention is also included in the technical scope of the present invention.

Although the above-described embodiments have portions described separately for convenience of explanation, it is needless to say that they may be implemented in combination within the technically possible range.

The program operating on each apparatus in the embodiments is a program for controlling the CPU (i.e., a program for operating a computer) to provide the functions according to the embodiments described above. The information handled in such an apparatus is temporarily stored in a temporary storage device (for example, RAM) when being processed. Then, the information is stored in a storage device such as a read only memory (ROM) or an HDD and, when necessary, is read, modified or written by the CPU.

The recording medium for storing the program may be any of a semiconductor medium (for example, a ROM or a non-volatile memory card), an optical recording medium/magneto-optical recording medium (for example, a digital versatile disc (DVD) or a magnetooptical (MO) disc), a mini disc (MD), a compact disc (CD), or a Blu-ray (registered trademark) disc (BD)), and a magnetic recording medium (for example, a magnetic tape or a flexible disc). By executing the loaded program, not only the functions of the above-described embodiments are realized. Moreover, by processing in cooperation with the operating system or another application program based on the instructions of the program, the features of the invention may be realized.

For market distribution, the program can be stored in a portable recording medium and transmitted to a server computer connected via a network such as the Internet. In this case, the storage device of the server computer is obviously included in the present invention.

What is claimed is:

1. An image forming apparatus comprising:
a controller that executes a job based on a setting value;
a storage that stores the setting value of the executed job as setting history information; and
a display unit that displays a selection screen for selecting the setting history information stored in the storage,
wherein the controller accepts a sharing setting for sharing the selected setting history information with users other than a user executing the job.

2. The image forming apparatus according to claim 1, wherein the display unit discloses the shared setting history information with the other users.

3. The image forming apparatus according to claim 2, wherein the controller accepts selection of the other users to whom the shared setting history information is to be disclosed.

4. The image forming apparatus according to claim 1, wherein the controller authenticates use of the shared setting history information by the other users.

5. The image forming apparatus according to claim 1, wherein when the job using the same setting history information is executed a predetermined number of time or more, the controller inquires whether or not to set the setting history information for sharing.

6. The image forming apparatus according to claim 1, wherein the controller searches the setting history information stored in the storage by using a predetermined search condition.

7. The image forming apparatus according to claim 1, wherein the storage stores the executed job as job history information.

8. A method of controlling an image forming apparatus that executes a job based on a setting value, the method comprising:
storing the setting value of the executed job as setting history information;
displaying a selection screen for selecting the setting history information stored in the storing; and
controlling,
the controlling including accepting a sharing setting for sharing the selected setting history information with users other than a user executing the job.
